(19) United States
(12) Patent Application Publication
(10) Pub. No.: US 2017/0251260 A1
(43) Pub. Date: Aug. 31, 2017

(54) SYSTEMS AND METHODS FOR SYNCHRONIZING MEDIA ASSET PLAYBACK ON MULTIPLE DEVICES

(71) Applicant: Rovi Guides, Inc., Santa Clara, CA (US)

(72) Inventor: Gary Sanders, Dripping Springs, TX (US)

(21) Appl. No.: 15/056,649

(22) Filed: Feb. 29, 2016

(51) Int. Cl. H04N 21/466; H04N 21/45; H04N 21/278; H04L 29/08; H04N 21/43; H04N 21/472; H04N 21/482; H04N 21/2668; H04N 21/242

(52) U.S. Cl. CPC H04N 21/4668; H04N 21/2668; H04N 21/4532; H04N 21/278; H04N 21/242; H04N 21/4302; H04N 21/47217; H04N 21/482; H04L 67/10

(57) ABSTRACT

Systems and methods are described herein for recommending media assets for a group. A media guidance application may generate recommendations for media assets along with indications of other users that may be interested in consuming the media asset. For example, the media guidance application may identify a media asset that matches a media preference of a first user and identify a second user connected to the first user in a social network, wherein the media asset matches at least one media preference associated with the second user. A media recommendation screen may be generated that includes both an indication of the media asset as well as an indication of the second user.

### BACKGROUND

Media-on-demand services have provided viewers with an increasing ability to organize group viewing sessions on multiple user devices. For example, even if users are separated by vast physical distances, they can still watch the same media-on-demand by accessing the media from the same content source at the same time. However, despite the ability to access the media from the same content source at the same time, not all viewers may be available at the same time. Accordingly, one viewer may not be able to watch content at the same time as another viewer. Moreover, even if one viewer does have time to watch content that viewer may not know other viewers that have time to watch or an interesting in watching the content.

Additionally, differences in network speed and/or differences in hardware/software capabilities of the user devices of different viewers in a group may cause one device to lag behind in playback from the other devices, requiring group members to constantly communicate and coordinate with other members regarding their progress through the media asset.

### SUMMARY

Accordingly, systems and methods are described herein for a media guidance application that facilitates group viewing and/or coordinates delivery of media content to multiple users and/or multiple devices. By facilitating group viewings, the media guidance application relieves a user of needing to know when other users are available to access content and what viewers are interested in accessing that content. By coordinating the delivery of the media content to the to multiple users and/or multiple devices, the users are no longer required to constantly communicate with each other regarding their respective progress through the media asset.

To facilitate a group viewing, the media guidance application may recommend media assets to a first user as well as one or more users that are also interested in the media assets. In some embodiments, the media guidance application may also recommend one or more timeslots which are suitable for watching the recommended media asset(s). As an illustrative example, the media guidance application may determine that a first user likes romantic comedies and may enjoy the romantic comedy “Love Actually.” The media guidance application may access a social media profile of the first user and identify a second user who is a “friend” of the first user in the social network and who also prefers romantic comedies. The media guidance application may suggest a group viewing session between the first user and the second user by generating a media recommendation screen that shows a listing of “Love Actually” as well as an indicator such as “Watch with Suzy!” to indicate that the second user may also be interested in watching the media asset.

As used herein, a “social network” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user.

In some aspects, a media guidance application may retrieve, from a first database, a media preference associated with a first user. As used herein, a “media preference” is data that indicates a choice, desire, inclination, option, favorite, propensity, or any other information that may be used to rank or select at least a subset of media. For example, a media preference for a user may be information associated with the user that may be used to predict media that the user prefers over other media. The media preference may be any data associated with the first user that indicates a preference for media assets, including, but not limited to, a genre preference, a preference for a particular program (such as a favorite program), a parental rating, or a preference for a timeslot. The first database may be any suitable data repository for storing information about the user. For instance, in some embodiments, the first database may be a local memory storing a user profile associated with the user. In some embodiments, the first database may be a remote database accessed by the media guidance application to download data associated with the user. For example, the first database may be a server associated with a social network which stores information about the user in remote memory.

The media guidance application may compare, using control circuitry, the media preference to metadata associated with a plurality of content. The media guidance application may compare the media preference to the metadata in any suitable manner. For instance, the media guidance application may perform a keyword search of the metadata for any instance of the media preference. As an illustrative example, the metadata for the plurality of content may indicate a genre associated with each of the content, and the media preference may indicate a genre preference of the user, such as “comedy.” In this illustrative example, the media guidance application may search for all content that is in the “comedy” genre, as indicated by its respective metadata. It will be understood that the foregoing example is provided for illustrative purposes only, and that other types of metadata and other methods of comparing the metadata to the media preference are contemplated. For instance, the plurality of content may be indexed or categorized based on other parameters in order to increase search speeds.

Based on the comparison of the media preference to the metadata associated with the plurality of content, the media guidance application may determine that a media asset of the plurality of content matches the media preference. For instance, as discussed in the illustrative example above, a subset of the content may belong to the “comedy” genre, which is preferred by the user.

The media guidance application may retrieve, from a second database, data indicating connections between users of a social network. In some embodiments, the second database may be the same as the first database. For instance, a single server associated with a social network may indicate both media preferences associated with the first user as well as connections of the user to other users in a social network. In some embodiments, the second database may be different than the first database. For instance, the database indicating connections of the user may be stored in a separate storage device than the database indicating the media preferences of the first user.

Based on the retrieved data from the second database, the media guidance application may identify a second user connected to the first user in the social network. As an illustrative example, the media guidance application may identify a “friend” of the first user. In some embodiments, the media guidance application may identify the second user which is connected to the first user up to a threshold number of links. For example, the data indicating connections between users may indicate that the first user and the second user are not directly connected, but are connected through one or more intermediate users. The media guidance application may identify the second user as being connected to the first user through a shortest path that is less than a threshold number of connections.

The media guidance application may further determine that the media asset is also preferred by the second user. For example, the media guidance application may retrieve media preferences associated with the second user. The media guidance application may retrieve these media preferences associated with the second user from the same database as the media preferences associated with the first user, or from a different database. The media guidance application may compare the media preferences associated with the second user to metadata associated with the media asset and determine that the media asset matches at least one media preference associated with the second user.

In response to determining that the media asset matches the media preference, and in response to determining that the media asset matches at least one media preference associated with the second user, the media guidance application may generate for display a media recommendation screen including an indication of the media asset and an indication of the second user. For example, the media guidance application may generate a list of recommendations, and with one or more of the recommendations for media assets, also indicate at least one other user who may be interested in consuming the respective media asset. In this manner, the media guidance application may not only display recommendations which are targeted to the first user, but also display one or more other users who may be interested in consuming the media asset with the first user.

In some embodiments, the media guidance application may also access a calendar or other indication of availabilities of the first user and the second user. The media guidance application may compare the calendars of the first user and the second user in order to determine one or more time periods where both the first user and the second user are available, wherein the time periods are the same or longer than the duration of the recommended media asset. The media guidance application may then optionally generate for display an indication of the one or more available time periods in addition to indications of the recommended media asset and users. In this manner, the media guidance application may aid the first user in organizing a group viewing session by recommending a media asset, one or more group members who may be interested in the media asset, as well as a time period when all group members are available.

In some embodiments, not all group members need have access to the media asset. For instance, a “premium” media asset may require a subscription in order to access. However, in some embodiments, only the first user of the group need have access to the media asset and may transmit the media asset to other group members who do not have access to the media asset through other means. In this manner, the first user may share his premium access to the media asset with other users who do not have the premium access or requisite subscriptions to access the media asset. In some embodiments, identifying the second user comprises identifying a user that does not have access to the media asset.

In some embodiments, the media guidance application will display several media asset recommendations, and only some, but not all, of the recommendations may have a recommendation for other users to watch the media asset with. For example, the media guidance application may identify a second media asset of the plurality of content that matches the media preference, wherein the media recommendation screen further includes an indication of the second media asset. The indication of the media asset may be generated for display together with the indication of the second user in a first portion of the media recommendation screen, and the indication of the second media asset may be generated for display in a second portion of the media recommendation screen without the indication of the second user. Thus, the media recommendation screen may provide a mix of both traditional media recommendations targeted only to the first user as well as media recommendations for group viewing sessions.

In some embodiments, the media recommendation screen may include selectable icons that allow the first user to select the media asset. In response to receiving the selection, the media guidance application may transmit a communication indicating the selection to the second user. In some embodiments, the media guidance application may generate the media content for simultaneous display on user devices associated with the first user and the second user.

To coordinate the delivery of the media content to multiple users and/or multiple devices, the media guidance application may synchronize the transmission of media content to different devices. For example, when viewing the same media asset using two different devices, media synchronization may become difficult to manage due to a variety of conditions, including the quality of the network connection and/or hardware/software capabilities of the respective devices. For example, users who wish to watch the same movie but are separated by a large geographical distance may wish to synchronize their viewing session so that they experience similar scenes of the movie at similar times. The media guidance application may synchronize the playback on the first and the second devices through the use of synchronization signals, such as timestamps, which indicate a progress of the first and the second devices as playback progresses. The media guidance application may monitor the playback of the media asset on the two devices and detect when playback has become unsynchronized, such as if the timestamps exceed a certain period of time. The media guidance application may pause playback on the device that is “ahead” and/or reduce the bitrate delivered to the device that is “behind” in order to allow the device that is “behind” to catch up in playback. Once the media guidance application detects that the two devices are synchronized, the media guidance application may resume playback on both devices. In this manner, the media guidance application may help keep the two devices synchronized without any additional input from users associated with the two devices.

The media guidance application may first transmit the media asset for simultaneous display to a first device and a second device. In some embodiments, the transmission may come from a central server. For instance, the first device and the second device may both individually access an Internet server that delivers the content simultaneously to the first device and the second device. In some embodiments, the transmission may come from either one of the first device or the second device. For example, the first device may access the media from a database and stream the media to the second device for simultaneous display on the first device and the second device.

The media guidance application may receive, at a first time, a first indication of an amount of the media asset consumed by the first device at the first time and a second indication of an amount of the media asset consumed by the second device at the first time. For example, the media guidance application may receive timestamps indicating playback times of the first device and the second device. In some embodiments, the indications may indicate an amount of the media asset that has been transmitted to the first or the second device. The indications may come from any suitable source, including local or remote memory. For example, the first device and the second device may access the media from one or more data servers, and the indications may come from the one or more data servers. In some embodiments, the first and/or the second device may generate and transmit the indications themselves. For instance, the first and/or the second device may periodically generate a synchronization signal that comprises, at least in part, a timestamp of the current time in playback for the respective device.

The media guidance application may compare, using control circuitry, the first indication and the second indication to determine that the amount of the media asset consumed by the first device at the first time is different than the amount of the media asset consumed by the second device at the first time. In some embodiments, the comparison may comprise comparing a timestamp associated with the first device with a timestamp associated with the second device and determining that the two timestamps exceed a threshold period of time. In response to determining that the amount of the media asset consumed by the first device is different than the amount of the media asset consumed by the second device, the media guidance application may pause playback of the media asset on one of the first device and the second device. For instance, the media guidance application may pause playback on the device that is “ahead,” allowing the device that is “behind” to catch up in playback.

At a second time subsequent to the first time, the media guidance application may receive a third indication of an amount of the media asset consumed by the first device at the second time and a fourth indication of an amount of the media asset consumed by the second device at the second time. The third and fourth indications may be substantially similar to the first and second indications, except taken at different time points. The media guidance application may then compare, using the control circuitry, the third indication and the fourth indication to determine that the amount of the media asset consumed by the first device at the second time is the same as the amount of the media asset consumed by the second device at the second time. This comparison may be substantially similar to the comparison of the first and second indications. For example, the media guidance asset may determine that timestamps associated with the first device and the second device are within a threshold period of time. In this manner, the media guidance application may determine that the device that was “behind” has now caught up. Thus, in response to determining that the amount of the media asset consumed by the first device at the second time is the same as the amount of the media asset consumed by the second device at the second time, the media guidance application may resume playback of the media asset on the one of the first device and the second device.

In some embodiments, the media guidance application may generate an alert to either one or both of the first or second device that the media asset playback has been paused. The alert may be removed when playback is resumed on both devices.

In some embodiments, in response to determining that the amount of the media asset consumed by the first device is different than the amount of the media asset consumed by the second device, the media guidance application may change a format of the media asset transmitted to at least one of the first device or the second device. For example, the media guidance application may lower the quality of the media asset from high definition to standard definition or otherwise lower the bitrate to the device that is “behind.” In this manner, the media guidance application may make it easier for the device that is “behind” to buffer the media content, reducing the probability of falling behind in the future.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media recommendation screen in accordance with some embodiments of the disclosure;

FIG. 2 shows an illustrative media playback screen in accordance with some embodiments of the disclosure;

FIG. 3 shows an illustrative example of a display screen for use in accessing media content in accordance with some embodiments of the disclosure;

FIG. 4 shows another illustrative example of a display screen used to access media content in accordance with some embodiments of the disclosure;

FIG. 5 is a block diagram of an illustrative user equipment device in accordance with some embodiments of the disclosure;

FIG. 6 is a block diagram of an illustrative media system in accordance with some embodiments of the disclosure;

FIG. 7 is a flowchart of illustrative steps for recommending a media asset in accordance with some embodiments of the disclosure;

FIG. 8 depicts illustrative pseudocode for recommending a media asset in accordance with some embodiments of the disclosure;

FIG. 9 is a flowchart of illustrative steps for transmitting a media asset for simultaneous display in accordance with some embodiments of the disclosure; and

FIG. 10 is a flowchart of illustrative steps for synchronizing playback of a media asset in accordance with some embodiments of the disclosure.

### DETAILED DESCRIPTION OF THE DRAWINGS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

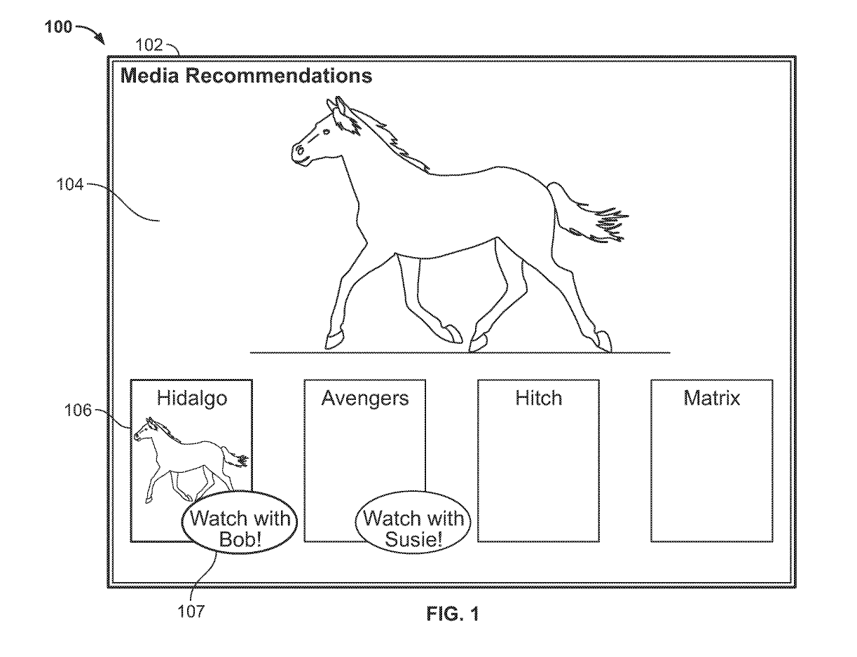

FIG. 1 shows an illustrative media recommendation screen 100 in accordance with some embodiments of the disclosure. Media recommendation screen 100 includes a display area 102, a preview area 104, one or more indications of media assets 106, and one or more indications of other users 107. It will be understood that the media recommendation screen 100 is provided for illustrative purposes only, and that other configurations and combinations of elements may be contemplated as will be understood by those of skill in the art. For instance, while the one or more indications of media assets 106 is depicted here as a horizontal arrangement of media asset icons, it will be understood that any suitable arrangement and ordering may be used, including, but not limited to, a text list of recommended media assets. Furthermore, although the one or more indications of other users 107 is depicted as an overlay icon on a respective indication of a media asset 106, it will be understood that the indications of other users 107 may be displayed in any suitable area of the screen, either with or without the respective indication of the associated media asset 106. For instance, in some embodiments, the media recommendation screen 100 may include a “provide group recommendations” icon for one or more of the recommended media assets. When this icon is selected by a first user, the media guidance application may generate a subsequent screen which includes the indications of other users 107 for the associated media asset.

By providing the indications of other users 107 in addition to the indications of media assets 106, the media guidance application may quickly provide relevant information to a first user to allow the first user to set up a group viewing session. For example, in the illustrative example depicted in FIG. 1, the user may quickly see that “Bob” also may enjoy Hidalgo. In some embodiments, the “Watch with Bob!” icon 107 may also be a selectable icon to allow the user to set up a group viewing session. For instance, in some embodiments, selection of the “Watch with Bob!” icon 107 may send a communication to Bob that the first user has selected Hidalgo for a group viewing session. In some embodiments, the indication of media asset 106 may be a separate selectable icon, and the communication to Bob may be sent to Bob in response to the user's selection of the indication of media asset 106.

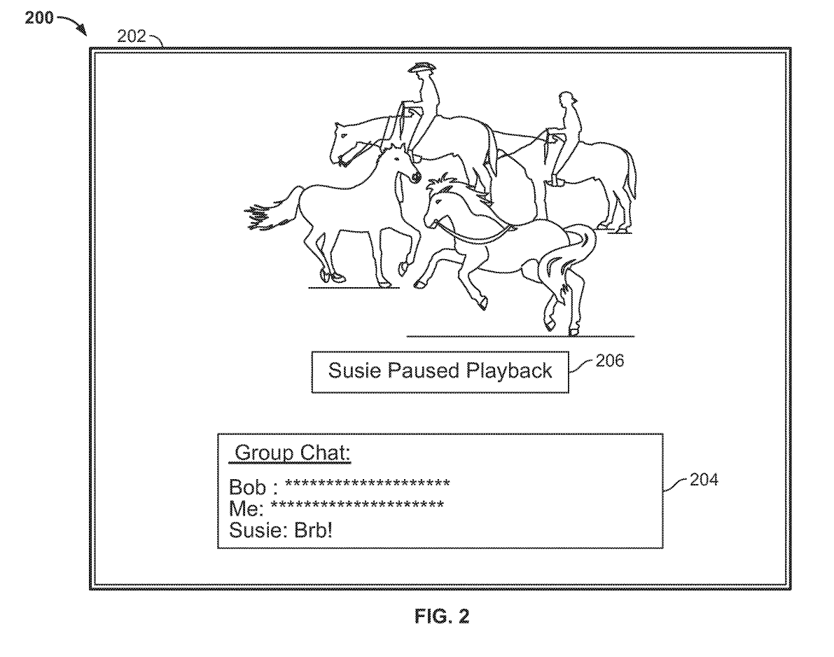

FIG. 2 shows an illustrative media playback screen 200 in accordance with some embodiments of the disclosure. Media playback screen 200 includes display area 202, group communication area 204, and alert 206.

As discussed above, in some embodiments, a group viewing session may be organized in which users associated with separate devices consume media assets simultaneously. Media playback screen 200 may represent a playback screen of a media asset on a first device that is also being simultaneously displayed on a second device. The group communication area 204 may allow users associated with the first and second devices to communicate. For example, as depicted in the illustrative example in FIG. 2, the group communication area 204 may be an interactive chat area which is overlayed onto the playing media asset.

The media guidance application may provide playback controls to one or more group members. For instance, in some embodiments, only a subset of group members (e.g., a group “leader”) may control playback of the media asset, including pause, play, rewind, and fast forward. In some embodiments, any of the group members may control playback of the media asset. Whenever a group member executes a playback action, the devices playing back the media asset may generate an alert indicating the playback action and/or the user who initiated the playback. In the illustrative example depicted in FIG. 2, Susie has paused playback, and the display depicts an alert 206 which shows the group member who has initiated the action (Susie) as well as the playback action (pause). In some embodiments, the execution of one playback function may “lock out” the other group members from executing another playback function until normal playback is restored by the user who first initiated the playback function. For example, in the illustrative example depicted in FIG. 2, once Susie pauses playback, the other group members may be unable to resume playback until Susie returns and initiates normal playback through the “play” function. In some embodiments, all group members may be able to control playback at all times. For example, in the illustrative example depicted in FIG. 2, any group member may resume playback once Susie has paused playback.

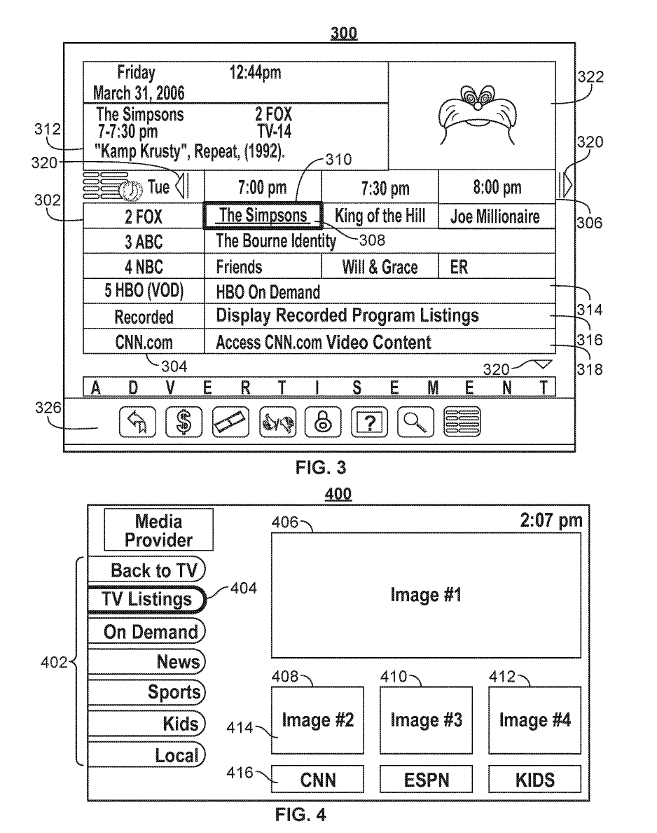

FIGS. 3-4 show illustrative display screens that may be used to provide media guidance data. The display screens shown in FIGS. 3-4 may be implemented on any suitable user equipment device or platform. While the displays of FIGS. 3-4 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 3 shows illustrative grid of a program listings display 300 arranged by time and channel that also enables access to different types of content in a single display. Display 300 may include grid 302 with: (1) a column of channel/content type identifiers 304, where each channel/content type identifier (which is a cell in the column) identifies a different channel or content type available; and (2) a row of time identifiers 306, where each time identifier (which is a cell in the row) identifies a time block of programming. Grid 302 also includes cells of program listings, such as program listing 308, where each listing provides the title of the program provided on the listing's associated channel and time. With a user input device, a user can select program listings by moving highlight region 310. Information relating to the program listing selected by highlight region 310 may be provided in program information region 312. Region 312 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 302 may provide media guidance data for non-linear programming including on-demand listing 314, recorded content listing 316, and Internet content listing 318. A display combining media guidance data for content from different types of content sources is sometimes referred to as a “mixed-media” display. Various permutations of the types of media guidance data that may be displayed that are different than display 300 may be based on user selection or guidance application definition (e.g., a display of only recorded and broadcast listings, only on-demand and broadcast listings, etc.). As illustrated, listings 314, 316, and 318 are shown as spanning the entire time block displayed in grid 302 to indicate that selection of these listings may provide access to a display dedicated to on-demand listings, recorded listings, or Internet listings, respectively. In some embodiments, listings for these content types may be included directly in grid 302. Additional media guidance data may be displayed in response to the user selecting one of the navigational icons 320. (Pressing an arrow key on a user input device may affect the display in a similar manner as selecting navigational icons 320.)

Display 300 may also include video region 322, and options region 326. Video region 322 may allow the user to view and/or preview programs that are currently available, will be available, or were available to the user. The content of video region 322 may correspond to, or be independent from, one of the listings displayed in grid 302. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 326 may allow the user to access different types of content, media guidance application displays, and/or media guidance application features. Options region 326 may be part of display 300 (and other display screens described herein), or may be invoked by a user by selecting an on-screen option or pressing a dedicated or assignable button on a user input device. The selectable options within options region 326 may concern features related to program listings in grid 302 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 6. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 4. Video mosaic display 400 includes selectable options 402 for content information organized based on content type, genre, and/or other organization criteria. In display 400, television listings option 404 is selected, thus providing listings 406, 408, 410, and 412 as broadcast program listings. In display 400 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 408 may include more than one portion, including media portion 414 and text portion 416. Media portion 414 and/or text portion 416 may be selectable to view content in full-screen or to view information related to the content displayed in media portion 414 (e.g., to view listings for the channel that the video is displayed on).

The listings in display 400 are of different sizes (i.e., listing 406 is larger than listings 408, 410, and 412), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

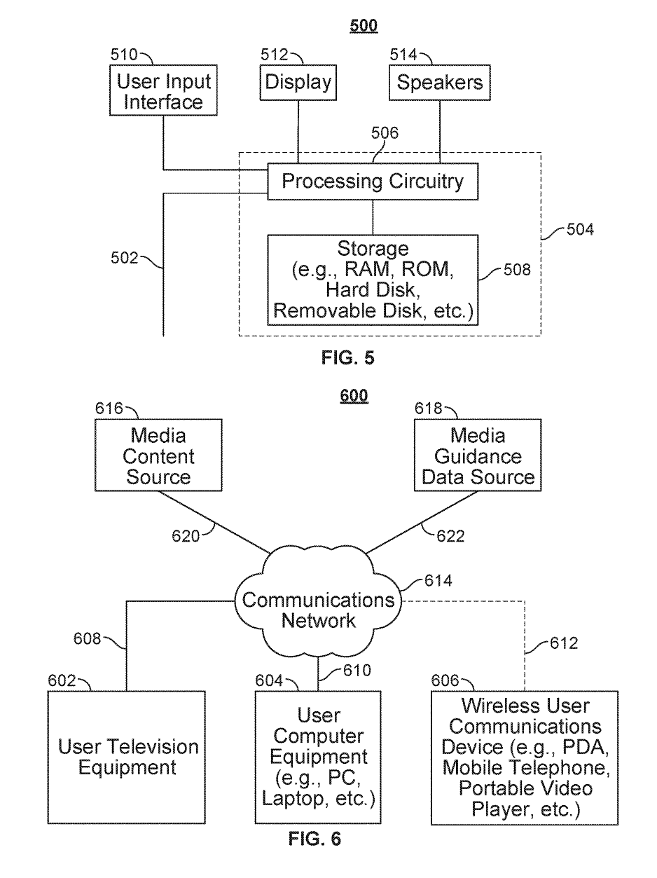

Users may access content and the media guidance application (and its display screens described above and below) from one or more of their user equipment devices. FIG. 5 shows a generalized embodiment of illustrative user equipment device 500. More specific implementations of user equipment devices are discussed below in connection with FIG. 6. User equipment device 500 may receive content and data via input/output (hereinafter “I/O”) path 502. I/O path 502 may provide content (e.g., broadcast programming, on-demand programming, Internet content, content available over a local area network (LAN) or wide area network (WAN), and/or other content) and data to control circuitry 504, which includes processing circuitry 506 and storage 508. Control circuitry 504 may be used to send and receive commands, requests, and other suitable data using I/O path 502. I/O path 502 may connect control circuitry 504 (and specifically processing circuitry 506) to one or more communications paths (described below). I/O functions may be provided by one or more of these communications paths, but are shown as a single path in FIG. 5 to avoid overcomplicating the drawing.

Control circuitry 504 may be based on any suitable processing circuitry such as processing circuitry 506. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions for a media guidance application stored in memory (i.e., storage 508). Specifically, control circuitry 504 may be instructed by the media guidance application to perform the functions discussed above and below. For example, the media guidance application may provide instructions to control circuitry 504 to generate the media guidance displays. In some implementations, any action performed by control circuitry 504 may be based on instructions received from the media guidance application.

In client-server based embodiments, control circuitry 504 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 508 may be used to store various types of content described herein as well as media guidance data described above. Nonvolatile memory may also be used (e.g., to launch a boot-up routine and other instructions). Cloud-based storage, described in relation to FIG. 6, may be used to supplement storage 508 or instead of storage 508.

Control circuitry 504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 504 may also include scaler circuitry for upconverting and downconverting content into the preferred output format of the user equipment 500. Circuitry 504 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 508 is provided as a separate device from user equipment 500, the tuning and encoding circuitry (including multiple tuners) may be associated with storage 508.

A user may send instructions to control circuitry 504 using user input interface 510. User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of user equipment device 500. For example, display 512 may be a touchscreen or touch-sensitive display. In such circumstances, user input interface 510 may be integrated with or combined with display 512. Display 512 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 512 may be HDTV-capable. In some embodiments, display 512 may be a 3D display, and the interactive media guidance application and any suitable content may be displayed in 3D. A video card or graphics card may generate the output to the display 512. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 504. The video card may be integrated with the control circuitry 504. Speakers 514 may be provided as integrated with other elements of user equipment device 500 or may be stand-alone units. The audio component of videos and other content displayed on display 512 may be played through speakers 514. In some embodiments, the audio may be distributed to a receiver (not shown), which processes and outputs the audio via speakers 514.

The guidance application may be implemented using any suitable architecture. For example, it may be a stand-alone application wholly-implemented on user equipment device 500. In such an approach, instructions of the application are stored locally (e.g., in storage 508), and data for use by the application is downloaded on a periodic basis (e.g., from an out-of-band feed, from an Internet resource, or using another suitable approach). Control circuitry 504 may retrieve instructions of the application from storage 508 and process the instructions to generate any of the displays discussed herein. Based on the processed instructions, control circuitry 504 may determine what action to perform when input is received from input interface 510. For example, movement of a cursor on a display up/down may be indicated by the processed instructions when input interface 510 indicates that an up/down button was selected.

In some embodiments, the media guidance application is a client-server based application. Data for use by a thick or thin client implemented on user equipment device 500 is retrieved on-demand by issuing requests to a server remote to the user equipment device 500. In one example of a client-server based guidance application, control circuitry 504 runs a web browser that interprets web pages provided by a remote server. For example, the remote server may store the instructions for the application in a storage device. The remote server may process the stored instructions using circuitry (e.g., control circuitry 504) and generate the displays discussed above and below. The client device may receive the displays generated by the remote server and may display the content of the displays locally on equipment device 500. This way, the processing of the instructions is performed remotely by the server while the resulting displays are provided locally on equipment device 500. Equipment device 500 may receive inputs from the user via input interface 510 and transmit those inputs to the remote server for processing and generating the corresponding displays. For example, equipment device 500 may transmit a communication to the remote server indicating that an up/down button was selected via input interface 510. The remote server may process instructions in accordance with that input and generate a display of the application corresponding to the input (e.g., a display that moves a cursor up/down). The generated display is then transmitted to equipment device 500 for presentation to the user.

In some embodiments, the media guidance application is downloaded and interpreted or otherwise run by an interpreter or virtual machine (run by control circuitry 504). In some embodiments, the guidance application may be encoded in the ETV Binary Interchange Format (EBIF), received by control circuitry 504 as part of a suitable feed, and interpreted by a user agent running on control circuitry 504. For example, the guidance application may be an EBIF application. In some embodiments, the guidance application may be defined by a series of JAVA-based files that are received and run by a local virtual machine or other suitable middleware executed by control circuitry 504. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 500 of FIG. 5 can be implemented in system 600 of FIG. 6 as user television equipment 602, user computer equipment 604, wireless user communications device 606, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 5 may not be classified solely as user television equipment 602, user computer equipment 604, or a wireless user communications device 606. For example, user television equipment 602 may, like some user computer equipment 604, be Internet-enabled allowing for access to Internet content, while user computer equipment 604 may, like some television equipment 602, include a tuner allowing for access to television programming. The media guidance application may have the same layout on various different types of user equipment or may be tailored to the display capabilities of the user equipment. For example, on user computer equipment 604, the guidance application may be provided as a web site accessed by a web browser. In another example, the guidance application may be scaled down for wireless user communications devices 606.

In system 600, there is typically more than one of each type of user equipment device but only one of each is shown in FIG. 6 to avoid overcomplicating the drawing. In addition, each user may utilize more than one type of user equipment device and also more than one of each type of user equipment device.

In some embodiments, a user equipment device (e.g., user television equipment 602, user computer equipment 604, wireless user communications device 606) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 614. Namely, user television equipment 602, user computer equipment 604, and wireless user communications device 606 are coupled to communications network 614 via communications paths 608, 610, and 612, respectively. Communications network 614 may be one or more networks including the Internet, a mobile phone network, mobile voice or data network (e.g., a 4G or LTE network), cable network, public switched telephone network, or other types of communications network or combinations of communications networks. Paths 608, 610, and 612 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 612 is drawn with dotted lines to indicate that in the exemplary embodiment shown in FIG. 6 it is a wireless path and paths 608 and 610 are drawn as solid lines to indicate they are wired paths (although these paths may be wireless paths, if desired). Communications with the user equipment devices may be provided by one or more of these communications paths, but are shown as a single path in FIG. 6 to avoid overcomplicating the drawing.

Although communications paths are not drawn between user equipment devices, these devices may communicate directly with each other via communication paths, such as those described above in connection with paths 608, 610, and 612, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 614.

System 600 includes content source 616 and media guidance data source 618 coupled to communications network 614 via communication paths 620 and 622, respectively. Paths 620 and 622 may include any of the communication paths described above in connection with paths 608, 610, and 612. Communications with the content source 616 and media guidance data source 618 may be exchanged over one or more communications paths, but are shown as a single path in FIG. 6 to avoid overcomplicating the drawing. In addition, there may be more than one of each of content source 616 and media guidance data source 618, but only one of each is shown in FIG. 6 to avoid overcomplicating the drawing. (The different types of each of these sources are discussed below.) If desired, content source 616 and media guidance data source 618 may be integrated as one source device. Although communications between sources 616 and 618 with user equipment devices 602, 604, and 606 are shown as through communications network 614, in some embodiments, sources 616 and 618 may communicate directly with user equipment devices 602, 604, and 606 via communication paths (not shown) such as those described above in connection with paths 608, 610, and 612.

Content source 616 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 616 may be the originator of content (e.g., a television broadcaster, a Webcast provider, etc.) or may not be the originator of content (e.g., an on-demand content provider, an Internet provider of content of broadcast programs for downloading, etc.). Content source 616 may include cable sources, satellite providers, on-demand providers, Internet providers, over-the-top content providers, or other providers of content. Content source 616 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

In some embodiments, the content source 616 may transmit or stream content to more than one device for simultaneous viewing. For example, a media asset provided by the content source 616 may be accessed by both a first device and a second device for simultaneous viewing. In addition to transmitting the media asset, the content source 616 may maintain indications of playback progress of the first device and the second device. For instance, in some embodiments, the content source 616 may maintain timestamps indicating a current time of playback for each of the first device and the second device. In some embodiments, the content source 616 may receive periodic synchronization signals from one or both of the first device and the second device, the synchronization signals including a timestamp or other progress indicator for playback of the media asset.

Media guidance data source 618 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 618 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 618 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 618 may provide user equipment devices 602, 604, and 606 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). In some embodiments, the media guidance data may include connections of the user to other users in a social network, such as users that the user has indicated as “friends.” The connections may also include multiple degrees of connections, such as “friends of friends” up to a certain threshold number of links. In this manner, the media guidance data may maintain a database of users connected to the user through a shortest path that is equal to or less than the threshold number of links. The database of users may be organized and maintained in any suitable manner, including, but not limited to, as a uni or bi-directional traversable graph network.

In some embodiments, the viewer data may include media preferences of the user, including, but not limited to, a genre preference, a preference for a particular program (such as a favorite program), a parental rating, and a preference for a particular timeslot (for example, primetime or Saturday morning). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 508, and executed by control circuitry 504 of a user equipment device 500. In some embodiments, media guidance applications may be client-server applications where only a client application resides on the user equipment device, and server application resides on a remote server. For example, media guidance applications may be implemented partially as a client application on control circuitry 504 of user equipment device 500 and partially on a remote server as a server application (e.g., media guidance data source 618) running on control circuitry of the remote server. When executed by control circuitry of the remote server (such as media guidance data source 618), the media guidance application may instruct the control circuitry to generate the guidance application displays and transmit the generated displays to the user equipment devices. The server application may instruct the control circuitry of the media guidance data source 618 to transmit data for storage on the user equipment. The client application may instruct control circuitry of the receiving user equipment to generate the guidance application displays.

Content and/or media guidance data delivered to user equipment devices 602, 604, and 606 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 600 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 6.

In one approach, user equipment devices may communicate with each other within a home network. User equipment devices can communicate with each other directly via short-range point-to-point communication schemes described above, via indirect paths through a hub or other similar device provided on a home network, or via communications network 614. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 616 to access content. Specifically, within a home, users of user television equipment 602 and user computer equipment 604 may access the media guidance application to navigate among and locate desirable content. Users may also access the media guidance application outside of the home using wireless user communications devices 606 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 614. These cloud resources may include one or more content sources 616 and one or more media guidance data sources 618. In addition or in the alternative, the remote computing sites may include other user equipment devices, such as user television equipment 602, user computer equipment 604, and wireless user communications device 606. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 604 or wireless user communications device 606 having content capture feature. Alternatively, the user can first transfer the content to a user equipment device, such as user computer equipment 604. The user equipment device storing the content uploads the content to the cloud using a data transmission service on communications network 614. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 5.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

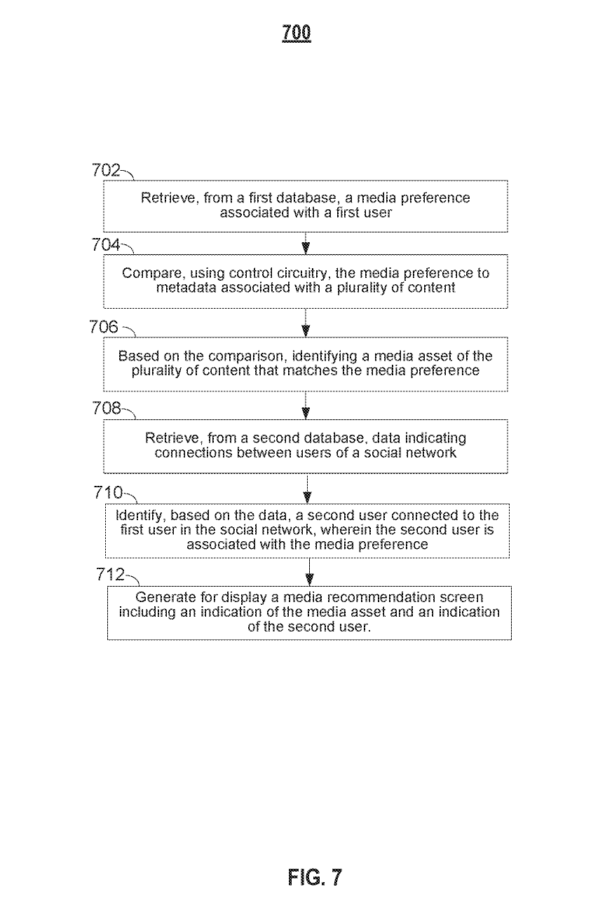

FIG. 7 is a flowchart of illustrative steps for recommending a media asset in accordance with some embodiments of the disclosure. It should be noted that process 700, or any step thereof, could occur on, or be provided by, any of the devices shown in FIGS. 5-6. For example, process 700 may be executed by control circuitry 504 (FIG. 5) as instructed by the media guidance application (e.g., implemented on any of the devices shown and described in FIG. 6).

At step 702, the media guidance application may retrieve (e.g., using control circuitry 504 (FIG. 5)), from a first database (e.g., storage 508 (FIG. 5) or media guidance data source 618 (FIG. 6)), a media preference associated with a first user. As discussed above, the first database may be a local memory (such as storage 508 (FIG. 5)) or remote memory (such as media guidance data source 618 (FIG. 6)). The media preference associated with the first user may be any preference associated with the first user that may be used to narrow media asset selections, including, but not limited to, a genre preference, a preference for a particular program, a parental rating, and a preference for a timeslot.

At step 704, the media guidance application may compare, using control circuitry (e.g., using control circuitry 504 (FIG. 5)), the media preference to metadata associated with a plurality of content. As discussed above, the media guidance application may compare the media preference and the metadata using any suitable method. For example, the media guidance application may perform a keyword search of the metadata for instances of the media preference. In some embodiments, the metadata associated with the plurality of content may be divided into fields that correspond to various media preference categories. For instance, the metadata may be divided into genre, actor/actresses, parental rating, and critic rating, among other fields. In some embodiments, the comparison for the media preference may search only fields associated with the media preference category. For example, a search for a user's genre preference may search only the “genre” field of the metadata associated with a plurality of content.

At step 706, based on the comparison, the media guidance application may identify (e.g., using control circuitry 504 (FIG. 5)) a media asset of the plurality of content that matches the media preference. For example, as discussed above, the media guidance application may identify a media asset that is associated with the preference or that is associated with metadata which contains an instance of the media preference.

At step 708, the media guidance application may retrieve (e.g., using control circuitry 504 (FIG. 5)), from a second database (e.g., storage 508 (FIG. 5) or media guidance data source 618 (FIG. 6)), data indicating connections between users of a social network. As discussed above, the second database which stores the indications of connections between the first user and other users of the social network may be the same database which stores media preferences of the first user. In some embodiments, the second database may be a different database than the first database. For example, the first database may be a user media profile stored on a user's set top box, which stores the user's media preferences, while the second database may be a remote database associated with a social network that indicates other users of the social network that the first user has indicated as “friends.”

At step 710, the media guidance application may identify (e.g., using control circuitry 504 (FIG. 5)), based on the data, a second user connected to the first user in the social network, wherein the second user is associated with the media preference. In some embodiments, the media guidance application may retrieve one or more media preferences associated with the second user and compare them to the media preference in order to identify a match. In some embodiments, the media guidance application may only retrieve a media preference associated with the second user that is the same type or category as the media preference. For example, if the media preference is a genre preference, then the media guidance application may retrieve a corresponding genre preference of the second user in order to determine if the second user may also be interested in the media asset.

At step 712, the media guidance application may generate for display (e.g., on display 512 (FIG. 5)), a media recommendation screen including an indication of the media asset and an indication of the second user. As an illustrative example, the indication of the media asset may be displayed together in a first portion of the media recommendation screen with the indication of the second user, as depicted in media recommendation screen 100 of FIG. 1.

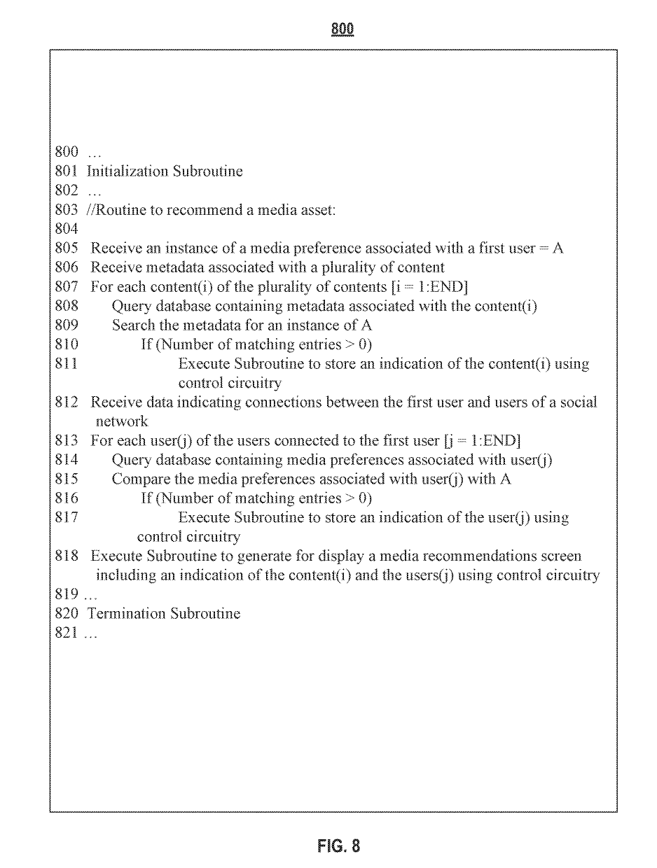

FIG. 8 depicts illustrative pseudocode 800 for recommending a media asset in accordance with some embodiments of the disclosure. It will be evident to one skilled in the art that the process described by the pseudocode in FIG. 8 may be implemented in any number of programming languages and a variety of different hardware, and that the style and format should not be construed as limiting, but rather a general template of the steps and procedures that would be consistent with code used to implement some embodiments of this disclosure.

At line 801, control circuitry 504 runs a subroutine to initialize variables and prepare to recommend a media asset, which begins on line 803. For example, in some embodiments control circuitry 504 may copy instructions from non-transitory storage medium (e.g., storage 508) into RAM or into the cache for processing circuitry 506 during the initialization stage.

At line 805, control circuitry 504 receives an instance of a media preference associated with the first user and stores it in the temporary variable “A”. In some embodiments these instances may be retrieved from memory, such as local storage 508 (FIG. 5) or media guidance data source 618 (FIG. 6), or from user input, such as an input through user input interface 510 (FIG. 5). Control circuitry 504 may receive instances of the user preference by receiving, for example, a pointer to an array of values of user preferences. In another example, control circuitry 504 may receive an object of a class, such as an iterator object containing elements of the user preference.

At line 806, the control circuitry 504 may receive instances of metadata associated with the plurality of content. In some embodiments these instances may be retrieved from memory, such as local storage 508 (FIG. 5) or media guidance data source 618 (FIG. 6). Control circuitry 504 may receive instances of the metadata by receiving, for example, a pointer to an array of values. In another example, control circuitry 504 may receive an object of a class, such as an iterator object containing elements of the metadata.

At line 807, control circuitry 504 iterates through the various instances of the content. If only a single instance is available, the loop will only execute once. This loop may be implemented in multiple fashions depending on the choice of hardware and software language used to implement the algorithm of FIG. 8; for example, this may be implemented as part of a “for” or “while” loop.

At line 808, control circuitry 504 queries a database, such as storage 508 (FIG. 5) or media guidance data source 618 (FIG. 6) for metadata associated with the instance of the content. At line 809, the control circuitry 504 searches the metadata for instances of the user preference A. For example, the control circuitry 504 may compare the value of A to value(s) contained in the metadata to see if they are essentially equivalent. In some embodiments, a partial match of one or more entries of the metadata may be sufficient to determine a match between the user preference A and the metadata. At 810, if the number of entries of the metadata and the user preference A is greater than 0, then the control circuitry 504 may execute a subroutine to store an indication of the content. For example, the control circuitry 504 may store an indication of the content in storage 508 (FIG. 5) for later retrieval.

At line 812, control circuitry 504 may receive data indicating connections between the first user and users of a social network. The data may be retrieved by communicating with a remote server, such as media guidance data source 618 (FIG. 6) through a network such as communications network 614 (FIG. 6). At 813, the control circuitry 504 may iterate through each of the users connected to the first user in the social network. At 814, the control circuitry 504 may query a database containing media preferences associated with a particular user. At 815, the control circuitry may compare the media preferences of the particular user with the value of A in order to determine if there are any matching entries. At 816, if the number of matching entries is greater than zero, then the control circuitry 504 may execute a subroutine to store an indication of the particular user to memory. For example, the control circuitry 504 may store an indication of the particular user in storage 508 (FIG. 5) for later retrieval.

At line 818, the control circuitry 504 may execute a subroutine to generate for display a media recommendations screen including an indication of all of the identified content and all of the identified users. For example, the control circuitry 504 may access storage 508 (FIG. 5) and retrieve all of the stored instances of content from line 811 and all of the stored instances of other users from line 817. The control circuitry 504 may access display 512 and generate for display a list of the retrieved indications of content and the indications of users, either together or separately.

At line 820, control circuitry 504 runs a termination subroutine after the algorithm has performed its function. For example, in some embodiments control circuitry 504 may destruct variables, perform garbage collection, free memory or clear the cache of processing circuitry 506.

It will be evident to one skilled in the art that process 800 described by the pseudocode in FIG. 8 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments break conditions may be placed throughout to speed operation, or the conditional statements may be replaced with a case-switch. In some embodiments, rather than iterating over all instances of the plurality of content at line 807, in some embodiments the code may be rewritten so control circuitry 504 is instructed to evaluate multiple instances of content simultaneously on a plurality of processors or processor threads, lowering the number of iterations needed and potentially speeding up computation time.

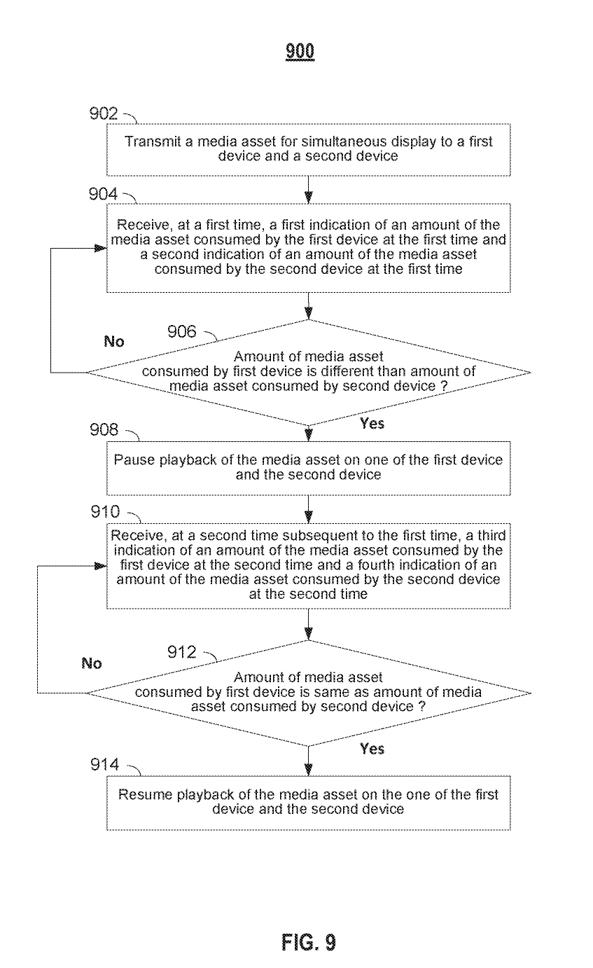

FIG. 9 is a flowchart of illustrative steps for transmitting a media asset for simultaneous display in accordance with some embodiments of the disclosure. It should be noted that process 900, or any step thereof, could occur on, or be provided by, any of the devices shown in FIGS. 5-6. For example, process 900 may be executed by control circuitry 504 (FIG. 5) as instructed by the media guidance application (e.g., implemented on any of the devices shown and described in FIG. 6).

The steps of FIG. 9 may facilitate the synchronization of two separate media streams to two separate user devices. For example, users may wish to experience the same media asset at the same time, but on their own user devices. As an illustrative example, the users may be separated by great physical distance and unable to consume the media asset in the same room on the same device. In some cases, a first user may stream the media content to all other users, and the first user may synchronize the stream so that all users may experience the media asset at approximately the same time. In other cases, each user may separately stream the media asset from one or more remote sources onto their own respective user devices. In such instances, synchronization of these separate media streams may be difficult and may require communication and manual adjustment by the individual users. For example, the individual streams may become out of sync due to a variety of conditions, including, for example, a difference in network bandwidth or a difference in hardware/software capabilities between the user devices. To this end, it is desirable to synchronize the separate streams of a media asset to separate user devices so that users may experience media at the same or similar time.

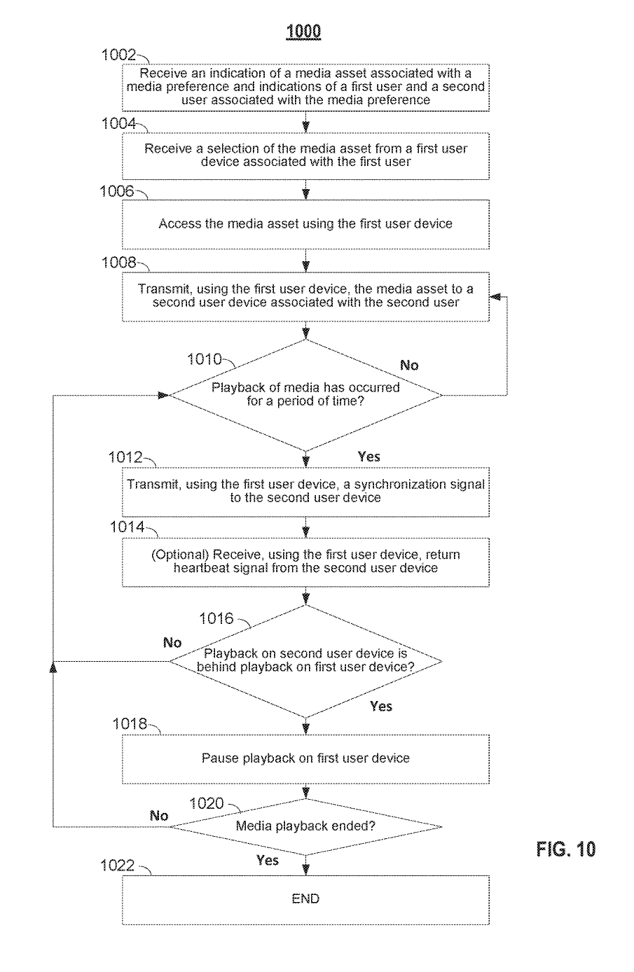

In order to synchronize these separate streams, the media guidance application may receive indications of an amount of the media asset consumed by each user device. As used herein, an “indication of an amount of the media asset” may comprise any data or metadata usable to determine a position or a portion of the media asset that has been consumed by a user device. For example, the indication may comprise a timestamp representative of a current time in playback of a media asset on the respective device, a time duration consumed or buffered, a percentage of the media asset duration, a qualitative indication of the media asset duration (for example, “beginning”, “middle,” “end”), or a portion of the media asset that has been transmitted to the respective device, among others. These indications may be received from any suitable source. For example, in some embodiments, the user devices themselves may generate the indications and transmit them, for example over network 614 (FIG. 6). In some embodiments, the media content source (such as media content source 616 (FIG. 6)) may generate indications of the amount of the media asset transmitted to the user devices, using this data as a proxy for an amount of the media asset consumed by the devices. Based on the received indications, the media guidance application may determine whether playback of the media asset has become out of sync on one or more of the receiving user devices, as discussed further blow in relation to FIGS. 9 and 10. In response to determining that one or more user devices has become out of sync, the media guidance application may transmit active playback controls, without user input or intervention, in order to facilitate the resynchronization of the playback. For example, for the one or more user devices that is “ahead” in playback (that is, playing the media asset at a point that is after other user devices), the media guidance application may pause the media asset or decrease playback speed of the media asset, or some combination of the above. For the one or more user devices that are “behind” in playback (that is, playing the media asset at a point that is before other user devices), the media guidance application may increase playback speed of the media asset, reduce the quality (e.g., high definition to standard definition, changing resolution/pixel densities), or change formats (e.g., media file types, encoding types such as MP4 or avi) of the media asset, or some combination of the above. The media guidance application may detect when the playback of the user devices has returned to within a threshold level (for example, within a certain time delay or within a percentage of the media asset duration) and resume normal playback on all user devices.

At step 902, the media guidance application may transmit (e.g., using control circuitry 504 (FIG. 5)) a media asset for simultaneous display to a first device and a second device. In some embodiments, the transmission may come from a central media source, such as media source 616 (FIG. 6). In some embodiments, the transmission may come from a user device, such as device 500 (FIG. 5). For example, the user device may access the media asset from a media source (e.g., media source 616 (FIG. 6)) and transmit the media to a first device, such as display 512 (FIG. 5). The user device may simultaneously stream the media to a second display device for simultaneous display with the first display device.

At step 904, the media guidance application may receive (e.g., using control circuitry 504 (FIG. 5)), at a first time, a first indication of an amount of the media asset consumed by the first device at the first time and a second indication of an amount of the media asset consumed by the second device at the first time. The indications may originate from any suitable source, including, for example a media source (e.g., content source 616 (FIG. 6)) or one of the first device or the second device.

At step 906, the media guidance application may determine (e.g., using control circuitry 504 (FIG. 5)) whether an amount of the media asset consumed by the first device is different than the amount of the media asset consumed by the second device. In this manner, the media guidance application may determine whether playback of the media asset on the two user devices may have become out of sync. As discussed above, the determination may be made in any suitable manner. For example, the media guidance application may compare (e.g., using control circuitry 504 (FIG. 5)) whether a difference in timestamps associated with playback of the media asset on the first and second devices has exceeded a threshold period of time. As an illustrative example, the media guidance application may determine that if the playback of the media asset on the two devices differs by more than one second, then playback is not in sync. If the media guidance application determines that the playback is not in sync, then the media guidance application may return to step 904 and receive further indications from the first and the second device. If the media guidance application determines that the playback is not in sync, then the media guidance application may continue to step 908.

At step 908, the media guidance application may pause playback (e.g., using control circuitry 504 (FIG. 5)) of the media asset on one of the first device and the second device. The media guidance application may pause playback on the device that is “ahead” in playback. For instance, the media guidance application may determine that one of the first device or the second device is “ahead” by comparing timestamps and determining that one of the first device and the second device has a current playback time that is later in time than the current playback time of the other device.

At step 910, the media guidance application may receive (e.g., using control circuitry 504 (FIG. 5)) at a second time subsequent to the first time, a third indication of an amount of the media asset consumed by the first device at the second time and a fourth indication of an amount of the media asset consumed by the second device at the second time. The third indication and fourth indication may be substantially similar to the first and second indications, except taken at a second, later time. At step 912, the media guidance application may determine (e.g., using control circuitry 504 (FIG. 5)) whether an amount of media asset consumed by the first device is the same or substantially the same as the amount of media asset consumed by the second device. At step 912, the media guidance application is essentially making a second comparison to determine if the media playback is back in sync on the two devices. For example, the media guidance application may compare timestamps associated with the playback of the media asset on the first and second devices and determine that the timestamps are within a certain threshold period of time. If the playback is not yet in sync (for example, if the timestamps still differ by greater than a threshold period of time), then the media guidance application may return to step 910. If the media playback is back in sync (for example, if the timestamps are within a threshold period of time), then the media guidance application may continue to step 914 and resume playback of the media asset on the one of the first device and the second device, whichever device was “paused” at step 908. In this manner, the media guidance application may automatically keep playback of the media asset in sync between the two devices without user input.

FIG. 10 is a flowchart of illustrative steps for synchronizing playback of a media asset in accordance with some embodiments of the disclosure. It should be noted that process 1000, or any step thereof, could occur on, or be provided by, any of the devices shown in FIGS. 5-6. For example, process 1000 may be executed by control circuitry 504 (FIG. 5) as instructed by the media guidance application (e.g., implemented on any of the devices shown and described in FIG. 6).

At step 1002, a media guidance application may receive (e.g., using control circuitry 504 (FIG. 5)) an indication of a media asset associated with a media preference and indications of a first user and a second user associated with the media preference. For example, the media guidance application may receive indications of the results of steps 702 to 712 discussed above in relation to FIG. 7. At step 1004, the media guidance application may receive (e.g., using control circuitry 504 (FIG. 5)) a selection of the media asset from a first user device associated with the first user. The selection may be received in any suitable manner, such as a user input by the first user using user input interface 510 (FIG. 5). At step 1006, the media guidance application may access the media asset using the first user device. As discussed above, the media asset may be associated with certain permissions, restrictions, or subscriptions that are associated with the first user device. The media asset may be retrieved from any suitable source, such as content source 616 (FIG. 6).

At step 1008, the media guidance application may transmit, using the first user device, the media asset to a second user device associated with the second user. In some embodiments, the second user device may also be associated with the requisite permissions, restrictions, and/or subscriptions required to access the media asset. In some embodiments, the second user device may not be associated with the requisite permissions, restrictions, and/or subscriptions required to access the media asset.

Step 1010 to step 1018 represent a series of steps taken by the media guidance application in order to synchronize the playback of the media asset on the first and second user devices via periodic synchronization signals. At step 1010, the media guidance application determines (e.g., using control circuitry 504 (FIG. 5)) whether playback of the media asset has occurred for a period of time. For example, the media guidance application may wait for the media asset to play back for a particular period of time. If the media asset has not played back for the period of time, the media guidance application returns to step 1008 and continues to transmit the media asset to the second user device using the first user device.

If the media asset has played back for the period of time, the media guidance application continues to step 1012 and transmits, using the first user device, a synchronization signal to the second user device. The synchronization signal may comprise any suitable data usable by the second user device to determine a playback time of the media asset on the first user device. For example, the synchronization signal may indicate a current playback time of the media asset on the first user device. The synchronization signal may also indicate a current playback percentage of the first media asset (for example, 50%) on the first user device.

At step 1014, the media guidance application may optionally receive, using the first user device, a return heartbeat signal from the second user device. As used herein, a “heartbeat signal” may be a periodic signal sent from a first device to a second device on a set or varying interval. The heartbeat signal may have been transmitted from the second user device and be usable to determine a current playback time of the media asset on the second user device. Thus, at step 1012 and step 1014, each user device may transmit data to the other user device(s) that allow the other device(s) to determine a current playback time of the other device(s).

At step 1016, the media guidance application may determine (e.g., using control circuitry 504 (FIG. 5)) whether playback on the second user device is behind playback on the first user device. For example, the media guidance application may determine that a playback time on the second user device is before a playback time on the first user device. If this is the case, then the media guidance application may continue to step 1018. If playback on the second user device is not behind playback on the first user device, then the media guidance application may return to step 1010 and wait to transmit the next synchronization signal at step 1012.

At step 1018, the media guidance may pause playback on the first user device. This may allow the second user device, which is “behind” in playback of the media asset, to catch up. At step 1020, the media guidance application determines (e.g., using control circuitry 504 (FIG. 5)) if media playback has ended. If so, then the media guidance application terminates the process step 1000 at step 1022. If media playback has not ended, then the media guidance application may return to step 1010 and wait to transmit the next synchronization signal at step 1012. At step 1016, if the media guidance application determines (e.g., using control circuitry 504 (FIG. 5)) that the playback on the second user device has “caught up,” then the media guidance application may unpause playback on the first user device and resume playback on both user devices. It will be understood that step 1016 may be a flexible determination by the media guidance application of whether one of the first user device or the second user device is ahead in playback of the media asset, and that responsive to a determination that one user device is ahead in playback, the other user device will be paused at step 1018.

Although FIGS. 7 through 10 are described in relation to a first device and a second device, it will be understood that the methods and systems described herein may be used with any number of devices. For example, a group viewing session may include three or more devices that all simultaneously display the same media asset. The methods and systems for transmitting the media asset for simultaneous display may be applied to these situations of three or more devices as well, mutatis mutandis. For example, upon a determination that one user device is “behind” playback of the other user devices, the media guidance application may pause playback on the other user devices to allow the user device that is “behind” to catch up in playback. As another illustrative example, the first user device may transmit the media asset to every other user device along with period synchronization signals, as discussed above in relation to FIG. 10.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for recommending media assets, the method comprising:
retrieving, from a first database, a media preference associated with a first user;
comparing, using control circuitry, the media preference to metadata associated with a plurality of content;
based on the comparison of the media preference to the metadata associated with the plurality of content, determining that a media asset of the plurality of content matches the media preference;
retrieving, from a second database, data indicating connections between users of a social network;
identifying, based on the data, a second user connected to the first user in the social network;
retrieving media preferences associated with the second user;
comparing the media preferences associated with the second user to metadata associated with the media asset;
determining that the media asset matches at least one media preference associated with the second user;
in response to determining that the media asset matches the media preference, and in response to determining that the media asset matches at least one media preference associated with the second user;
comparing calendars of the first user and the second user to determine a recommended time period that is equal to or exceeds a duration of the media asset that the calendars indicate is available for both the first user and the second user; and
generating for display a media recommendation screen including an indication of the media asset an indication of the second user, and an indication of the recommended time period.

2. The method of claim 1, wherein comparing the media preference to the metadata comprises performing a keyword search of the metadata for the media preference.

3. The method of claim 1, wherein identifying the second user comprises identifying a user that does not have access to the media asset.

4. The method of claim 1, wherein the data also indicates a respective media preference associated with each respective user of the plurality of users.

5. The method of claim 1, wherein the media preference is one of a genre preference, a preference for a program, a parental rating, and a preference for a timeslot.

6. The method of claim 1, further comprising identifying a second media asset of the plurality of content that matches the media preference, wherein the media recommendation screen further includes an indication of the second media asset.

7. The method of claim 6, wherein the indication of the media asset is generated for display together with the indication of the second user in a first portion of the media recommendation screen, and wherein the indication of the second media asset is generated for display in a second portion of the media recommendation screen without the indication of the second user.

8. The method of claim 1, wherein the users of the social network include the first user and the second user.

9. The method of claim 1, further comprising:
receiving a selection from the first user of the media asset;
in response to receiving the selection, transmitting a communication indicating the selection to the second user.

10. The method of claim 1, further comprising generating the media content for simultaneous display on user devices associated with the first user and the second user.

11. A system for recommending media assets, the system comprising:
control circuitry configured to:
retrieve, from a first database, a media preference associated with a first user;
compare the media preference to metadata associated with a plurality of content;
based on the comparison of the media preference to the metadata associated with the plurality of content, determine that a media asset of the plurality of content matches the media preference;
retrieve, from a second database, data indicating connections between users of a social network;
identify, based on the data, a second user connected to the first user in the social network;
retrieve media preferences associated with the second user;
compare the media preferences associated with the second user to metadata associated with the media asset;
determine that the media asset matches at least one media preference associated with the second user;
in response to determining that the media asset matches the media preference, and in response to determining that the media asset matches at least one media preference associated with the second user;
compare calendars of the first user and the second user to determine a recommended time period that is equal to or exceeds a duration of the media asset that the calendars indicate is available for both the first user and the second user; and
generate for display a media recommendation screen including an indication of the media asset, an indication of the second user, and an indication of the recommended time period.

12. The system of claim 11, wherein the control circuitry is configured to compare the media preference to the metadata by performing a keyword search of the metadata for the media preference.

13. The system of claim 11, wherein the control circuitry is configured to identify the second user by identifying a user that does not have access to the media asset.

14. The system of claim 11, wherein the data also indicates a respective media preference associated with each respective user of the plurality of users.

15. The system of claim 11, wherein the media preference is one of a genre preference, a preference for a program, a parental rating, and a preference for a timeslot.

16. The system of claim 11, wherein the control circuitry is further configured to identify a second media asset of the plurality of content that matches the media preference, wherein the media recommendation screen further includes an indication of the second media asset.

17. The system of claim 16, wherein the indication of the media asset is generated for display together with the indication of the second user in a first portion of the media recommendation screen, and wherein the indication of the second media asset is generated for display in a second portion of the media recommendation screen without the indication of the second user.

18. The system of claim 11, wherein the users of the social network include the first user and the second user.

19. The system of claim 11, wherein the control circuitry is further configured to:
receive a selection from the first user of the media asset;
in response to receiving the selection, transmit a communication indicating the selection to the second user.

20. The system of claim 11, wherein the control circuitry is further configured to generate the media content for simultaneous display on user devices associated with the first user and the second user.

21-50. (canceled)
